(19) United States
(12) Patent Application Publication
(10) Pub. No.: US 2012/0103305 A9
(43) Pub. Date: May 3, 2012

(54) Method for regulating a combustion engine

(75) Inventors: Robert Boewing, Frankenthal (DE); Hans-Bernhard Snuis, Plankstadt (DE); Karsten Spreitzer, Weinheim (DE)

(73) Assignee: MWM GMBH, MANNHEIM (DE)

(21) Appl. No.: 13/138,361

(22) PCT Filed: Feb. 11, 2010
(86) PCT No.: PCT/EP2010/051743

§ 371 Date: Aug. 5, 2011

(30) Foreign Application Priority Data
Feb. 13, 2009 (DE) 102009008960.8 13

(51) Int. Cl. F02P 5/145

(52) U.S. Cl. 123/406.55

(57) ABSTRACT

A reciprocating engine and a method for regulating a reciprocating engine, in which a combustion chamber temperature θ-_{BRT} in one or more cylinders is made available, wherein the combustion chamber temperature θ-_{BRT} in the respective cylinder is measured, and the ignition point is individually regulated in one or more cylinders in such a way that an upward or downward deviation of the combustion chamber temperature θ-_{BRT} from a predefined desired value S is minimal.

### FIELD OF THE INVENTION

The invention concerns a method for regulating a combustion engine or a reciprocating engine, in which a combustion chamber temperature in one or more cylinders is made available.

### BACKGROUND OF THE INVENTION

It is already known, especially for large engines, how to detect the combustion chamber temperature of one or more cylinders by means of a thermo-element in order to provide a lambda control without a lambda probe. In this case, the combustion chamber temperature represents a substitute quantity for the mix ratio. Lambda sensors are not always used for large engines, due to limited lifetime.

DE 198 98 829 A1 describes a gas engine with a pilot control unit and an engine knock monitoring mechanism connected in front of the pilot control. The pilot control has a temperature sensor for detecting the charging air and/or mix temperature, but not the combustion chamber temperature. The pilot control unit generates set point values for actuating of servomechanisms, such as an ignition time adjusting device. The engine knock monitoring mechanism, on the other hand, has a temperature sensor to detect the combustion chamber temperature. However, only the power of the diesel gas engine is limited in two stages or a stop signal for the gas engine is generated in dependence on the combustion chamber temperature. No changing or regulating of the ignition angle or the ignition time as a function of the detected combustion chamber temperature is provided.

DE 102 57 994 A1 describes an activating of the engine knock limiting control, i.e., an adapting of the ignition angle depending on a change in the engine temperature or the coolant temperature, but not the combustion chamber temperature. A similar situation is described by DE 103 33 994 A1, which mentions the engine temperature as the manipulated variable for the ignition angle. With this, the torque contribution of the individual cylinder is adapted.

DE 38 33 124 A1 describes a device for monitoring a spark-ignition combustion engine, in which the calculation of a cylinder temperature is done in order to monitor the ignition time. Only in the event that a calculated cylinder temperature reaches an upper limit value is the ignition time delayed individually for the particular cylinder.

### SUMMARY OF THE INVENTION

The basic problem of the invention is to configure an engine regulating system or an engine such that excessive stresses on the structural parts are avoided and an interruption-free operation as well as an improved efficiency are assured.

During the combustion in a reciprocating engine, differences occur from cylinder to cylinder in the combustion and thus in the combustion chamber temperature as a measure of the combustion. The differences result especially from deviations in the air ratio, the homogeneity of the mixture, the charging motion, the wall temperatures, the tolerances of the structural parts and the oil entry across valves and pistons. They bring about deviations of the individual cylinders from the optimal position of the combustion center of gravity and from the completeness of the fuel conversion and thus lead to an impairment of the engine efficiency. Thus far, control engineering does not respond to the described differences in combustion from one cylinder to another.

Furthermore, uncontrolled combustion states can occur in one or more cylinders in the reciprocating engine, especially auto-ignitions and pre-ignitions, which are not detected by the acceleration pickup of the antiknock control system (AKR). The mentioned uncontrolled combustion states lead to an increased stress on structural parts, as well as impaired engine efficiency, and in extreme cases they require a shutoff of the engine. Thus far, control engineering does not respond to the described combustion problems.

The problem is solved according to the invention by a method for regulating a reciprocating engine, in which a combustion chamber temperature (θ_{BRT}) in one or more cylinders is made available, wherein the combustion chamber temperature (θ_{BRT}) is measured in the particular cylinder and the ignition time in one or more cylinders is individually regulated in that the upward and/or downward deviation of the combustion chamber temperature (θ_{BRT}) from a predefined desired value S is minimal and a reciprocating engine that is controlled and/or regulated. According to the invention, the ignition time in one or more cylinders, preferably in each cylinder, is individually regulated in that the upward and/or downward deviation of the combustion chamber temperature in the cylinder from a predefined desired value S is minimal. The combustion chamber temperature as the basic variable is the time-average temperature occurring at the thermo-element during the operation of the combustion engine. By avoiding too high or too low a combustion chamber temperature, one can reduce the differences in combustion from one cylinder to another, i.e., equalize the cylinders, and thereby improve the efficiency. On the other hand, one can reduce uncontrolled combustion states in one or more cylinders that are not identified by the antiknock control system, thereby reducing the stress on structural parts and/or preventing an engine shutdown.

The desired value S need not be statistical. It can also be varied in dependence on the parameters influencing the combustion, such as the charge stage or the fuel used. One most often uses a coordination between the desired value and the engine efficiency as a function of the NOx content of the exhaust gas.

In the case of regulation of a spark ignition engine, the time of the spark ignition is varied in dependence on the combustion chamber temperature, while when regulation a Diesel engine the injection time is regulated in dependence on the combustion chamber temperature.

Thus, a lessening of the differences in the combustion from one cylinder to another and an improved efficiency is achieved in that the mean combustion chamber temperature in each cylinder is measured with a thermo-element and the ignition is then regulated individually for each cylinder so that roughly the same mean combustion chamber temperature obtains in each cylinder. The adjusting of the individual cylinder's ignition time or ignition angle is done as a function of the deviation of the individual cylinder's combustion chamber temperature from a desired value. This can be the mean value of the combustion chamber temperature of all cylinders. The measure of the ignition time adjustment, especially its maximum and minimum value, and the other regulation constants are parametrizable. In the most simple case, this involves the amplification of a proportional controller.

It can also be advantageous in the case when the combustion chamber temperature exceeds the desired value S by a value K1 to delay the ignition time of the particular cylinder by a value Z1 with

0<K1<=M1,

5K<=M1<=20K,

0°<=Z1<=Zm

and

10°<=Zm<=40°.

As soon as the combustion chamber temperature deviates upward from the desired value, the ignition time is delayed, so that the combustion chamber temperature again drops.

Accordingly, it can be advantageous in the case when the combustion chamber temperature drops below the desired value S by a value K2 to advance the ignition time of the particular cylinder by a value Z2 with

0<K2<=M2,

K<=M2<=20K,

0°<=Z2<=Zm

and 10°<=Zm<=20°.

The readjustment of the ignition time also applies in the case of a downward deviation of the combustion chamber temperature.

If the combustion chamber temperature in the cylinders is adjusted so that the combustion chamber temperatures of the various cylinders deviate at most by a value dK with 5K<=dK<=20K, then a critical loading of structural parts on account of different combustion properties of the cylinders is practically ruled out. A uniform distribution of load among the cylinders is guaranteed.

The adjusting of the value K1 or K2 as the measure of the permissible deviation from the desired value S is done preferably on a test stand, so that the efficiency is optimized.

In addition, it can be advantageously provided that, when the combustion chamber temperature of a cylinder reaches or exceeds a limit value G1 above the desired value S, the ignition time of the particular cylinder is delayed by a value Z3 with

S+K3a<G1<=S+K3b,

5K<=K3a<=20K,

or K3a=10K,

80K<=K3b<=200K

or K3b=120K

and 10°<=Z3<=40°.

Alternatively or in addition to the above described method of regulating the combustion chamber temperature to the desired value, a monitoring of the combustion chamber temperature is provided so that, upon an abrupt rise of the combustion chamber temperature to or beyond the limit value G1, a corresponding change occurs in the ignition time.

The ignition time of the particular cylinder can be delayed abruptly to the value Z3 or the ignition of the particular cylinder can be shut off for one or more cycles and/or the fuel supply shut off as a whole.

Self-ignitions and pre-ignitions can thus die down. If the self-ignitions or pre-ignitions last too long, the ignition of the cylinder should be shut off for several cycles so as to prevent a critical combustion and the accompanying disadvantages for stress of the structural parts and the efficiency. In the case of a Diesel engine, the fuel injection of the cylinder would be interrupted. If these means do not work, both in the case of the spark-ignition engine and the Diesel engine the fuel supply as a whole should be interrupted, which would involve a shutdown of the engine. This should be avoided.

A lessening of uncontrolled combustion states in one or more cylinders that are not recognized by the antiknock control system and an improved efficiency are thus achieved in that the mean combustion chamber temperature in each cylinder is measured with a thermo-element and the ignition is then individually regulated for the cylinder. Upon spontaneous rise in the combustion chamber temperature of one or more cylinders above a predefined desired value, an abrupt adjustment of the ignition time or ignition angle leads to less stress on the structural parts and prevents the engine from having to be shut off.

In connection with the configuration and arrangement according to the invention it can be advantageous, if the ignition time is advanced individually for each cylinder, to turn on the ignition once again and/or turn on the fuel supply once again as soon as the combustion chamber temperature of the particular cylinder has dropped to an activation value A with

G1−5K>=A>=G1−200K

or G1−10K>=A>=G1−100K

or S1+100K>=A>=S1.

With the use of a practicable activation value A, which does not necessarily have to be statistically formed, but instead can be varied during the operation, the return to normal regulation of the ignition time in terms of the desired value S as described above is possible. The activation value A can also be varied in dependence on the parameters influencing the combustion, as explained in the introduction. Once the combustion chamber temperature of the one or more cylinders affected drops again below a predefined limit value or reaches the activation value, the ignition is then regulated individually per cylinder.

In this connection, it can be advantageous, in the event that the combustion chamber temperature of a cylinder reaches or falls below a limit value G2 beneath the desired value S, to advance the ignition time of the particular cylinder abruptly or in steps by a value Z4 with

S−K4a<=G1<=S−K4b,

80K<=K4a<=120K

or K4a=100K,

5K<=K4b<=15K

or K4b=10K

and 5°<=Z4<=20°.

This ensures a corresponding regulation upon drop in the combustion chamber temperature.

Moreover, it can be advantageous to use, as the desired value S, a mean value of the combustion chamber temperatures of several or all cylinders whose temperature is being detected. In this case, the desired value S will vary. If the combustion chamber temperature should rise or fall uniformly in all cylinders, the regulation in terms of the desired value S would not take hold, inasmuch as it is not dependent on the NOx value, since the desired value as a pure mean value would likewise rise or fall. The limit value regulation would then ensure a desired regulation intervention.

The use of the mean combustion chamber temperature of a cylinder that is detected during the operation as the combustion chamber temperature makes the method very simple and understandable. The thermo-element has a practicable position and picks up the temperatures occurring there. Thanks to the time resolution capability of the thermo-element, a relatively uniform course of the combustion chamber temperature is thus determined.

Having a thermo-element in each cylinder for detecting of the combustion chamber temperature ensures an equal position for all cylinders.

### BRIEF DESCRIPTION OF THE DRAWINGS

Further benefits and details of the invention are explained in the patent claims and in the description, and presented in the figures. There are shown:

FIG. 1, a regulating layout;

FIG. 2, a T/t diagram of the temperature curve of the combustion chamber temperature under influence of various regulating processes of the ignition time;

FIG. 3, a reciprocating engine schematic.

### DETAILED DESCRIPTION OF THE INVENTION

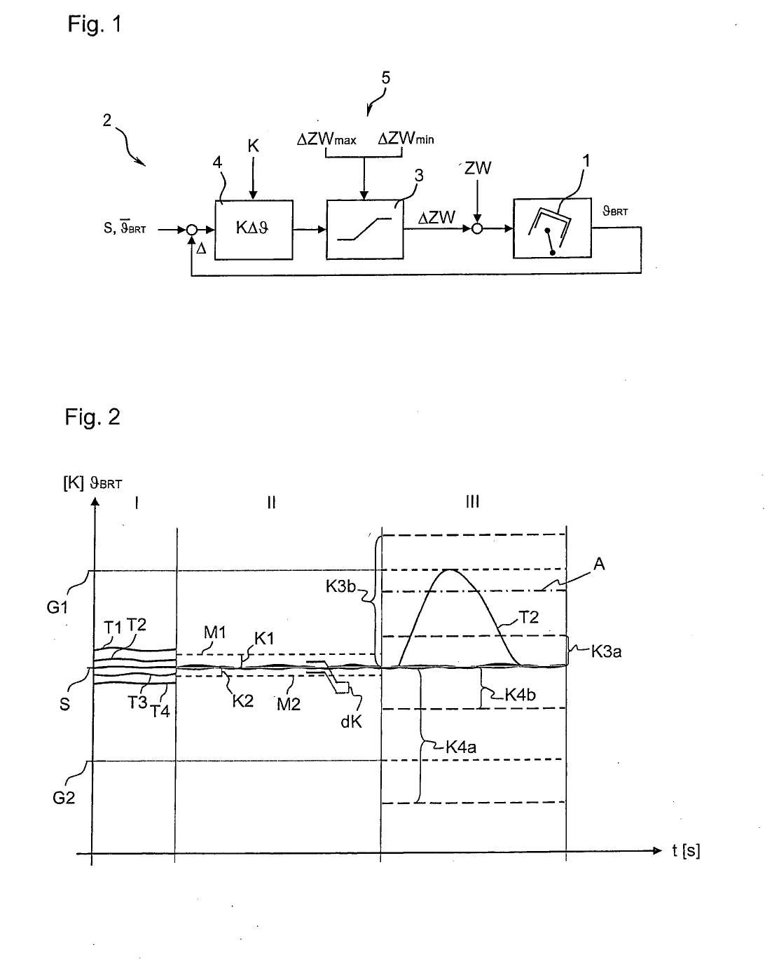

The regulating algorithm for the regulation process of an ignition time or ignition angle ZW according to the invention is implemented by means of a regulating circuit 2 shown in FIG. 1.

A mean combustion chamber temperature θ̅_{BRT} of all cylinders 1 is compared, as the desired value S, with an average combustion chamber temperature θ_{BRT} actually determined in the cylinder 1.

The adjusting of the ignition angle ZW is done by use of a proportional controller 4 under influence of a temperature difference Δθ found during the comparison, making use of a proportionality constant K as well as a manipulated variable limiting unit 5, consisting of a controller 3, in which a maximum (ΔZWmax) and a minimum (ΔZWmin) change ΔZW in the ignition angle ZW is considered and which ultimately puts out the change ΔZW in the ignition angle ZW.

After comparing and adapting the ignition angle ZW with the change ΔZW in the ignition angle ZW, the changed individual combustion per cylinder and the newly occurring combustion chamber temperature θ_{BRT} of the particular cylinder 1 is detected.

FIG. 2 shows a diagram of the combustion chamber temperature θ_{BRT} in Kelvin (K) against the time t in seconds (s), divided into three phases I, II, and III, for which the different regulation variants are indicated.

Per phase I, four combustion chamber temperatures T1, T2, T3 and T4 are detected. All combustion chamber temperatures T1-T4 are of different height and vary somewhat. A desired value S, as the mean of the four temperatures, is also shown. This also varies over the course of time (t).

Per phase II, deviations of the respective combustion chamber temperatures T1, T2, T3 and T4 from the desired value S are detected and regulated by intervention in the ignition time. The particular combustion chamber temperature may only exceed the desired value S by at most a temperature deviation value K1 and rise to a maximum temperature M1, or fall below the desired value S by at most a value K2 to a minimum temperature M2, before the regulation takes effect. The temperature deviations K1, K2 are in relation to the desired value S. Preferably, the deviation of the combustion chamber temperatures T1-T4 lies within a temperature range dK of 5K to 20K.

Per phase III, the particular combustion chamber temperature T1-T4 is monitored for reaching or exceeding or falling below a limit value G1 or G2. The limit value G1 and G2 is in relation to the desired value S, depending on temperature deviations K3a, K3b, K4a, K4b. The upper limit value G1 moves between the maximum temperature value S+K3b and the minimum temperature value S+K3a. The lower limit value G2 moves between the lower minimum temperature value S−K4a and the upper temperature value S−K4b. Once a combustion chamber temperature T2 reaches the set limit value G1, a corresponding and distinct delaying of the ignition time or a shutoff of the ignition occurs, so that the combustion chamber temperature T2 again falls. Once the combustion chamber temperature T2 reaches an activation value A, the ignition time is again advanced or the ignition again activated. In a case not shown, when a combustion chamber temperature reaches the set lower limit value G2, a corresponding advancing of the ignition time occurs.

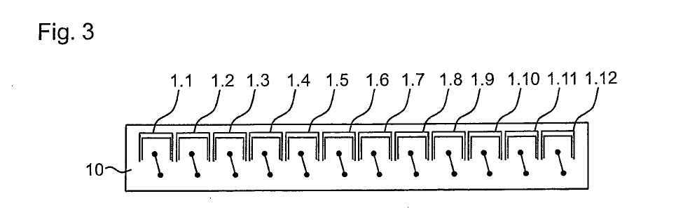

The reciprocating engine 10 shown in FIG. 3 has twelve cylinders 1.1-1.12, while each cylinder 1.1-1.12 has a thermo-element (not shown) to detect the individual combustion chamber temperature.

### LIST OF REFERENCE SYMBOLS

1 cylinder
1.1-1.12 cylinder
2 regulating circuit
3 controller
4 proportional controller
5 limiting of manipulated variables
10 reciprocating engine
A activation value of the BRT
dK temperature range
G1 limit value
G2 limit value
K proportionality constant
K1 temperature deviation
K2 temperature deviation
K3a temperature deviation
K3b temperature deviation
K4a temperature deviation
K4b temperature deviation
M1 maximum temperature
M2 minimum temperature
S desired value of the BRT
T1 combustion chamber temperature, BRT
T2 combustion chamber temperature, BRT
T3 combustion chamber temperature, BRT
T4 combustion chamber temperature, BRT
Zm maximum ignition angle adjustment
Zw ignition angle
θ̅_{BRT} mean combustion chamber temperature
θ_{BRT} combustion chamber temperature
Δθ temperature difference
ΔZW change in ignition angle ZW
ΔZWmax maximum change in ignition angle ZW
ΔZWmin minimum change in ignition angle ZW

What is claimed is:

1. A method for regulating a reciprocating engine, in which a combustion chamber temperature (θ_{BRT}) in one or more cylinders is made available, comprising the steps of:
measuring the mean combustion chamber temperature θ_{BRT}) in the particular cylinder and individually regulating an ignition time in one or more cylinders in that an upward and/or downward deviation of the combustion chamber temperature (θ_{BRT}) from a predefined desired value S is minimal.

2. The method according to claim 1, wherein when the combustion chamber temperature (θ_{BRT}) exceeds the desired value S by a value K1, the ignition time of the particular cylinder is delayed by a value Z1 with
0<K1<=M1,
5K<=M1<=20K,
0°<=Z1<=Zm
and
10°<=Zm<=40°.

3. The method according to claim 1, wherein when the combustion chamber temperature (θ_{BRT}) drops below the desired value S by a value K2, the ignition time of the particular cylinder is advanced by a value Z2 with
0<K2<=M2,
K<=M2<=20K,
0°<=Z2<=Zm
and
10°<=Zm<=20°.

4. The method according to claim 1, wherein the combustion chamber temperature (θ_{BRT}) in the cylinders is adjusted so that the combustion chamber temperatures (θ_{BRT}) of the various cylinders fluctuate at most in a temperature range dK about the desired value S with
5K<=dK<=20K.

5. The method according to claim 1, wherein when the combustion chamber temperature (θ_{BRT}) of a cylinder reaches or exceeds a limit value G1 above the desired value S, the ignition time of the particular cylinder is delayed by a value Z3 with
S+K3a<G1<=S+K3b,
5K<=K3a<=20K or K3a=10K,
80K<=K3b<=200K or K3b=120K
and
10°<=Z3<=40°.

6. The method according to claim 5, wherein the ignition time of the particular cylinder is delayed abruptly to the value Z3 or the ignition of the particular cylinder is shut off for one or more cycles and/or a fuel supply is shut off as a whole.

7. The method according to claim 5, wherein the ignition time is advanced individually for each cylinder, the ignition is turned on once again and/or a fuel supply is turned on once again as soon as the combustion chamber temperature (θ_{BRT}) of the particular cylinder has dropped to an activation value A with
G1−5K>=A>=G1−200K
or
G1−10K>=A>=G1−100K
or
S1+100K>=A>=S1.

8. The method according to claim 1, wherein in an event that the combustion chamber temperature (θ_{BRT}) of a cylinder reaches or falls below a limit value G2 beneath the desired value S, the ignition time of the particular cylinder is advanced abruptly or in steps by a value Z4 with
S−K4a<=G1<=S−K4b,
80K<=K4a<=120K or K4a=100K,
5K<=K4b<=15K or K4b=10K
and
5°<=Z4<=20°.

9. The method according to claim 1, wherein a mean value ( θ̅_{BRT}) of the combustion chamber temperatures (θ_{BRT}) of several or all cylinders whose temperature is being detected is used as the desired value S.

10. The method according to claim 1, wherein the mean combustion chamber temperature of a cylinder that is detected during the operation is used as the combustion chamber temperature (θ_{BRT}).

11. A reciprocating engine that is controlled and/or regulated according to claim 1.

12. The reciprocating engine according to claim 11, wherein a thermo-element is provided in each cylinder for detecting of the combustion chamber temperature.

13. The method according to claim 2, wherein when the combustion chamber temperature (θ_{BRT}) drops below the desired value S by a value K2, the ignition time of the particular cylinder is advanced by a value Z2 with
0<K2<=M2,
5K<=M2<=20K,
0°<=Z2<=Zm
and
10°<=Zm<=20°.

14. The method according to claim 13, wherein the combustion chamber temperature (θ_{BRT}) in the cylinders is adjusted so that the combustion chamber temperatures (θ_{BRT}) of the various cylinders fluctuate at most in a temperature range dK about the desired value S with
5K<=dK<=20K.

15. The method according to claim 14, wherein when the combustion chamber temperature (θ_{BRT}) of a cylinder reaches or exceeds a limit value G1 above the desired value S, the ignition time of the particular cylinder is delayed by a value Z3 with
S+K3a<G1<=S+K3b,
5K<=K3a<=20K or K3a=10K,
80K<=K3b<=200K or K3b=120K
and
10°<=Z3<=40°.

16. The method according to claim 15, wherein the ignition time of the particular cylinder is delayed abruptly to the value Z3 or the ignition of the particular cylinder is shut off for one or more cycles and/or a fuel supply is shut off as a whole.

17. The method according to claim 16, wherein the ignition time is advanced individually for each cylinder, the ignition is turned on once again and/or the fuel supply is turned on once again as soon as the combustion chamber temperature (θ_{BRT}) of the particular cylinder has dropped to an activation value A with
G1−5K>=A>=G1−200K
or
G1−10K>=A>=G1−100K
or
S1+100K>=A>=S1.

18. The method according to claim 8, wherein a mean value (θ_{BRT}) of the combustion chamber temperatures (θ_{BRT}) of several or all cylinders whose temperature is being detected is used as the desired value S.

19. The method according to claim 18, wherein the mean combustion chamber temperature of a cylinder that is detected during the operation is used as the combustion chamber temperature (θ_{BRT}).
